(19) United States
(12) Patent Application Publication
(10) Pub. No.: US 2017/0226971 A1
(43) Pub. Date: Aug. 10, 2017

(54) STRADDLE-TYPE VEHICLE

(71) Applicant: Kawasaki Jukogyo Kabushiki Kaisha, Kobe-shi, Hyogo (JP)

(72) Inventors: Norimasa Yamamoto, Kakogawa-shi (JP); Hiroshi Kato, Kakogawa-shi (JP); Naoto Yoshida, Akashi-shi (JP)

(21) Appl. No.: 15/502,159

(22) PCT Filed: Aug. 7, 2014
(86) PCT No.: PCT/JP2014/004131

§ 371 Date: Feb. 6, 2017

(51) Int. Cl. F02M 35/10; F02B 61/02; F02D 23/00; F02B 33/00

(52) U.S. Cl. CPC F02M 35/10163; F02B 33/00; F02B 61/02; F02D 23/005

(57) ABSTRACT

A straddle-type vehicle comprises a supercharging device which compresses intake-air, an air-intake chamber which is disposed downstream of the supercharging device, a pressure rising suppressing valve which is actuated by a pressure and connected to an inner space of the air-intake chamber, the pressure rising suppressing valve being configured to open the inner space of the air-intake chamber to a relief passage, in a case where a difference between a preset pressure in a pilot space and a pressure in the air-intake chamber reaches a predetermined value or more, a control valve which is electrically actuated and is capable of performing switching of a space to be in communication with the pilot space, between a high-pressure space and a low-pressure space; and a valve controller which provides to the control valve an operation command for controlling the control valve.

### TECHNICAL FIELD

The present invention relates to a straddle-type vehicle. In particular, the present invention relates to a straddle-type vehicle including a supercharging device which compresses intake-air.

### BACKGROUND ART

A pressure rising suppressing valve which is actuated by a pressure (pressure actuated pressure rising suppressing valve) is disclosed as an air-intake bypass device of a supercharging device (e.g., see Patent Literature 1, or the like). The pressure rising suppressing valve is connected to the inner space of an air-intake chamber. The pressure rising suppressing valve is configured to open the inner space of the air-intake chamber to a relief passage, when a difference between a preset pressure in a pilot space and a pressure in the air-intake chamber reaches a predetermined value or more.

### CITATION LIST

### Patent Literature

Patent Literature 1: International Publication No. 2011/046098 Specification

### SUMMARY OF INVENTION

### Technical Problem

However, the above-described pressure actuated pressure rising suppressing valve has a problem that a timing at which the pressure rising suppressing valve opens the inner space of the air-intake chamber to the relief passage cannot be properly set. To properly set the timing at which the pressure rising suppressing valve opens the inner space of the air-intake chamber to the relief passage, an electrically actuated valve (electric valve) may be used. However, the electric valve has a heat resistance lower than that of the pressure actuated pressure rising suppressing valve, and it is difficult to increase the size of the electric valve. For these reasons, it is difficult to use the electric valve itself, instead of the pressure actuated valve used as the conventional pressure rising suppressing valve.

The present invention has been made to solve the above-described problem, and an object of the present invention is to provide a straddle-type vehicle which is capable of properly setting a timing at which the inner space of an air-intake chamber is opened.

According to an aspect of the present invention, a straddle-type vehicle comprises: a supercharging device which compresses intake-air; an air-intake chamber which is disposed downstream of the supercharging device, stores therein the intake-air having been compressed by the supercharging device, and guides (leads) the intake-air to a combustion chamber of an engine; a pressure rising suppressing valve which is actuated by a pressure and connected to an inner space of the air-intake chamber, the pressure rising suppressing valve being configured to open the inner space of the air-intake chamber to a relief passage, in a case where a difference between a preset pressure in a pilot space and a pressure in the air-intake chamber reaches a predetermined value or more; a control valve which is electrically actuated and is capable of performing switching of a space to be in communication with the pilot space, between a high-pressure space and a low-pressure space; and a valve controller which provides to the control valve an operation command for controlling the control valve.

In accordance with this configuration, the pressure rising suppressing valve which is mechanically actuated and has a heat resistance higher than that of an electrically controlled valve is used. Therefore, even in a case where the temperature of the interior of the air-intake chamber is high, the pressure rising suppressing valve can be properly actuated. The pressure rising suppressing valve is controlled to be opened or closed by the electrically actuated control valve actuated in response to an operation command provided by the valve controller. Since the valve controller provides the operation command to the control valve, the pressure rising suppressing valve is opened or closed at a desired timing. This makes it possible to properly set the timing at which the inner space of the air-intake chamber is opened to the relief passage.

The high-pressure space may be the inner space of the air-intake chamber. In accordance with this configuration, in a case where the control valve causes the high-pressure space and the pilot space to be in communication with each other, a pressure difference between the pilot space and the interior of the air-intake chamber is eliminated. This makes it possible to prevent a situation in which the pressure rising suppressing valve is opened by mistake.

The low-pressure space may be an atmospheric pressure space. In accordance with this configuration, if the pressure in the air-intake chamber is high in a case where the control valve causes the low-pressure space and the pilot space to be in communication with each other, a pressure difference can be generated between the pilot space and the interior of the air-intake chamber. Therefore, at a time point when the pressure difference reaches a predetermined value or more, the pressure rising suppressing valve can be properly opened. Further, even in a case where the throttle valve has a failure, the relief passage can be easily opened.

The straddle-type vehicle may comprise a throttle device disposed between the air-intake chamber and an intake port of the engine, to adjust a flow rate of the intake-air to be supplied to the engine, wherein the low-pressure space may be an air-intake passage located downstream of the throttle device. The air-intake passage located downstream of the throttle device tends to have a pressure (negative pressure) lower than an atmospheric pressure, in a case where the air-intake passage is closed by the throttle device. Therefore, the responsivity of the pressure rising suppressing valve can be improved. In a case where the pressure rising suppressing valve is biased to be closed by the biasing mechanism, the pressure rising suppressing valve is moved in a direction opposite to the basing direction of the biasing mechanism. Therefore, by making use of the negative pressure, a force against the biasing force applied by the biasing mechanism can be easily obtained. Therefore, the biasing force applied by the biasing mechanism can be increased. As a result, it becomes possible to prevent a situation in which the pressure rising suppressing valve is undesirably opened.

The valve controller may control the control valve based on a value corresponding to an intake-air amount of the supercharging device and the pressure in the air-intake chamber. In accordance with this configuration, since the control valve is controlled based on an actual engine characteristic, the pressure rising suppressing valve can be controlled more properly. The valve controller may control the control valve based on a value corresponding to an intake-air amount of the supercharging device and a throttle valve opening degree or a throttle operation amount. The pressure in the air-intake chamber changes depending on the throttle valve opening degree even when the intake-air amount of the supercharging device is equal. Therefore, the pressure rising suppressing valve can be controlled more properly by controlling the control valve based on the throttle valve opening degree or the throttle operation amount which is a command value of the throttle valve opening degree.

The straddle-type vehicle may further comprise a failure determination unit which determines whether or not there is a failure in the pressure rising suppressing valve; and an engine output controller which suppresses an output of the engine to suppress a pressure increase of the air-intake chamber, in a case where the failure determination unit determines that the control valve cannot cause the pressure rising suppressing valve to open the inner space of the air-intake chamber to the relief passage. In accordance with this configuration, even in a case where the control for the pressure rising suppressing valve cannot be performed sufficiently, a pressure increase of the inner space of the air-intake chamber can be suppressed.

The above and further objects, features and advantages of the present invention will more fully be apparent from the following detailed description of preferred embodiment with reference to accompanying drawings.

### Advantageous Effects of Invention

The present invention has been configured as described above. The present invention can obtain an advantage that the timing at which the inner space of the air-intake chamber is opened can be properly set.

### BRIEF DESCRIPTION OF DRAWINGS

FIG. 1 is a left side view showing a motorcycle according to Embodiment 1 of the present invention.

FIG. 2 is a block diagram showing the schematic configuration of an air-intake passage of the motorcycle of FIG. 1.

FIG. 3 is a graph showing a relation between an intake-air flow rate and a pressure (internal pressure) in an air-intake chamber.

FIG. 4 is a block diagram showing the schematic configuration of an air-intake passage of a motorcycle according to Embodiment 2 of the present invention.

### DESCRIPTION OF EMBODIMENTS

Hereinafter, the embodiments of the present invention will be described with reference to the drawings. Throughout the drawings, the same or corresponding components are designated by the same reference symbols and will not be described repeatedly. In the present embodiments, a motorcycle will be exemplarily described as a straddle-type vehicle. The directions stated below are from the perspective of a rider straddling the motorcycle.

### Embodiment 1

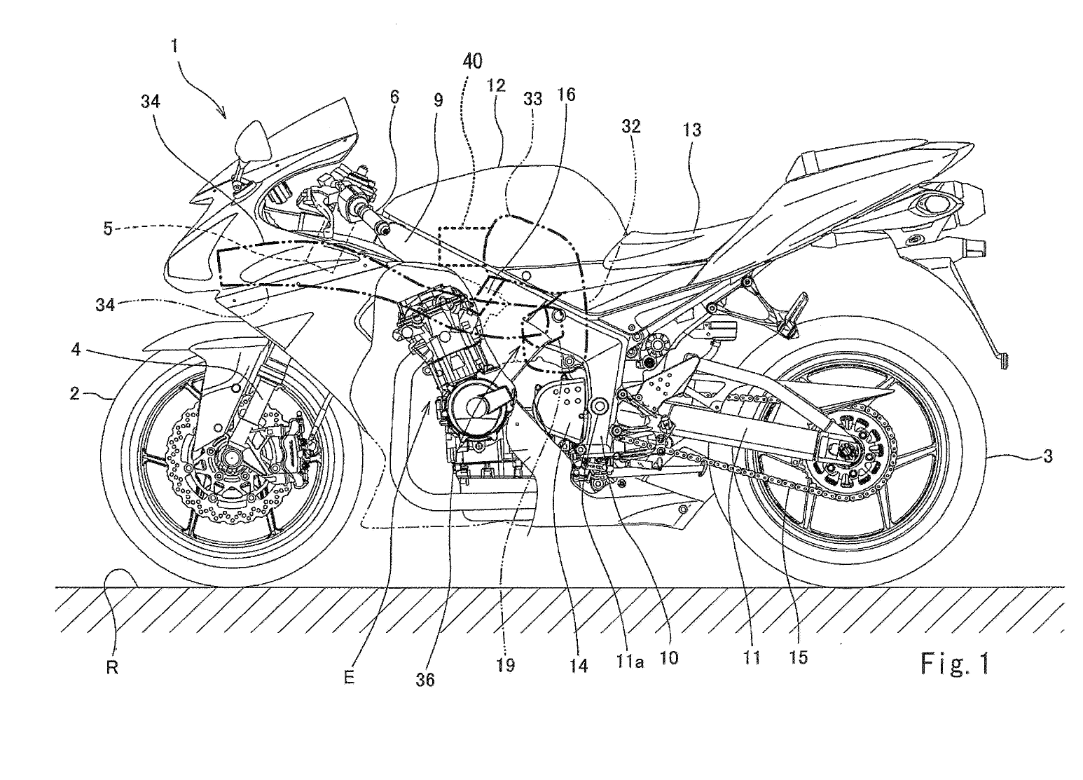

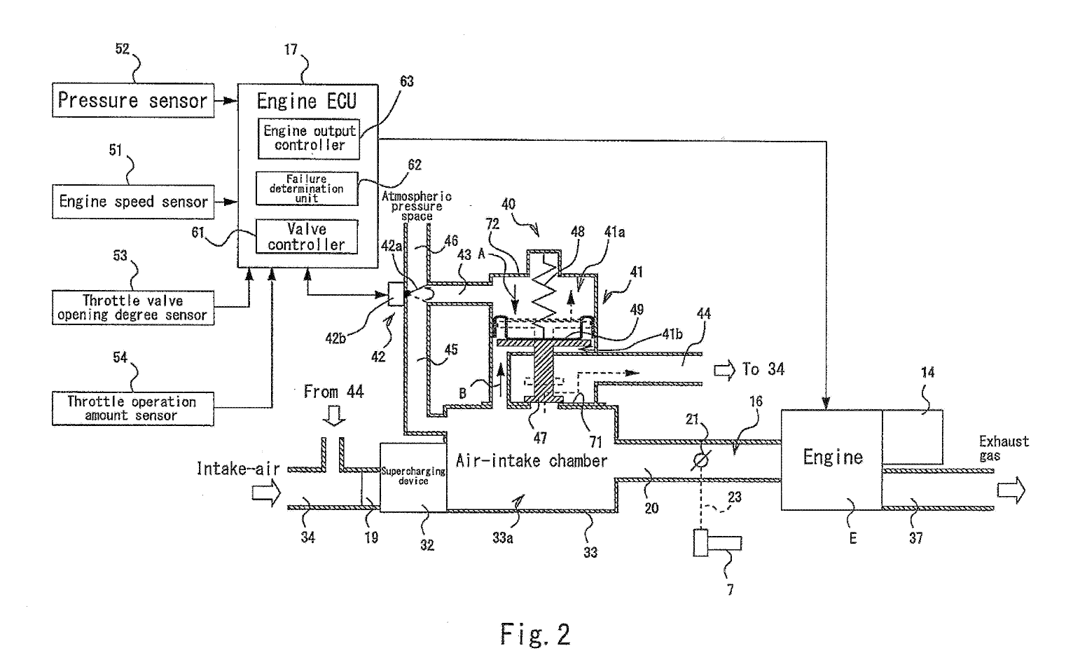

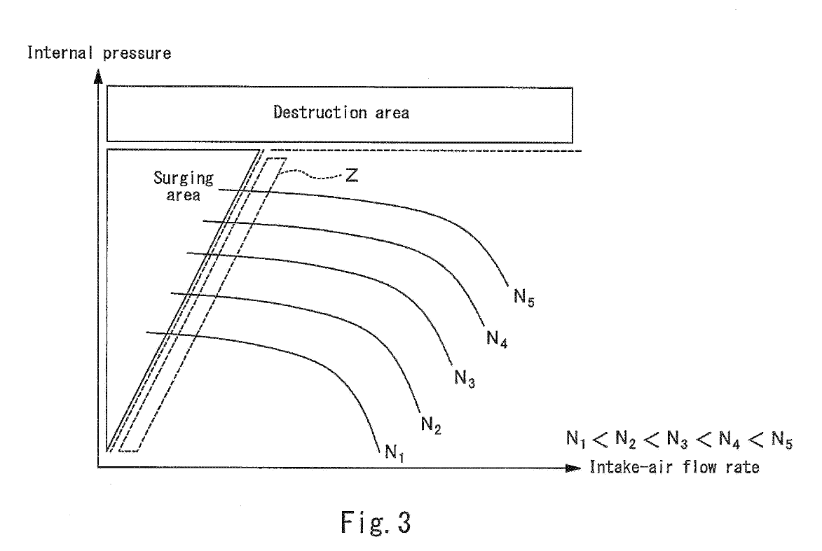

FIG. 1 is a left side view showing a motorcycle according to Embodiment 1 of the present invention. FIGS. 2 and 3 are block diagrams each showing the schematic configuration of an air-intake passage of the motorcycle of FIG. 1. As shown in FIG. 1, a motorcycle 1 includes a front wheel 2 and a rear wheel 3 which roll on a road surface R. The rear wheel 3 is a drive wheel, and the front wheel 2 is a driven wheel. The front wheel 2 is rotatably mounted to the lower end portion of a front fork 4 vertically extending. The front fork 4 is supported by a steering shaft. The steering shaft is rotatably supported by a head pipe 5. A bar-type steering handle 6 extending in a rightward and leftward direction is attached to an upper bracket.

A throttle grip 7 (see FIG. 2) provided at a portion of the handle 6 which can be gripped by the rider's right hand is a throttle input member which is rotated by twisting the rider's wrist to operate a throttle device 16 which will be described later. The rider rotates the handle 6 to turn the front wheel 2 in a desired direction around the steering shaft as a rotational shaft.

A pair of right and left main frames 9 extend rearward from the head pipe 5 in such a manner that the main frames 9 are tilted in a downward direction. A pair of right and left pivot frames 10 are connected to the rear portions of the pair of right and left main frames 9, respectively. The front end portions of a swing arm 11 extending in a substantially forward and rearward direction are mounted to the pivot frames 10 in such a manner that the swing arm 11 is pivotable. The rear wheel 3 is mounted to the rear end portion of the swing arm 11 in such a manner that the rear wheel 3 is pivotable around a pivot shaft 11a. The pivot shaft 11a of the swing arm 11 is disposed rearward relative to the rear end portion of an engine E. A fuel tank 12 is disposed rearward relative to the handle 6, and a straddle seat 13 which can be straddled by the rider is disposed behind the fuel tank 12.

Between the front wheel 2 and the rear wheel 3, an engine E is mounted to the main frames 9 and the pivot frames 10. FIG. 1 shows as the engine E an inline four-cylinder engine including four cylinders arranged in a vehicle width direction. A transmission 14 is connected to the output shaft of the engine E. Driving power output from the transmission 14 is transmitted to the rear wheel 3 via a chain 15. The engine E and the transmission 14 are integrated in such a manner that a transmission case of the transmission 14 is located behind a crankcase of the engine E. When viewed from a side, the axes of the cylinders are tilted in a forward direction as they extend in an upward direction. When viewed from the side, the crankcase of the engine E and the transmission case of the transmission 14 have a substantially L-shape as a whole. In other words, the engine E and the transmission 14 comprise the L-shaped case.

An air-intake device 36 is disposed upstream of the engine E, connected to the engine E via an air-intake passage 20, and located below a fuel tank 12. The air-intake device 36 includes a supercharging device 32 which compresses the intake-air, and an air-intake chamber 33 disposed downstream of the supercharging device 32. Upstream of the supercharging device 32, an air-intake duct 34 into which air flowing from forward is introduced, and an air cleaner 19 located between the air-intake duct 34 and the supercharging device 32, are disposed. The intake-air introduced through the air-intake duct 34 is sent to the supercharging device 32 via the air cleaner 19. In other words, the supercharging device 32 is disposed downstream of the air cleaner 19. The supercharging device 32 is driven by driving power of the engine E which is transmitted through a driving power transmission mechanism such as gears and a chain, namely the rotation of a crankshaft, and compresses the intake-air sent to the supercharging device 32. The supercharging device 32 includes a centrifugal pump and an epicyclic gear mechanism. The supercharging device 32 is configured to increase the speed of the driving power of the engine E. The centrifugal pump and the epicyclic gear mechanism are coaxial with each other. The centrifugal pump and the epicyclic gear mechanism are mounted to the upper wall portion of a transmission case. Alternatively, the supercharging device 32 may have a structure other than the above-described centrifugal type, for example, a constant-volume structure.

The throttle device 16 is disposed between the air-intake chamber 33 and intake ports (not show) of the engine E and adjusts the flow rate of the intake-air to be supplied from the air-intake device 36 to the engine E. The throttle device 16 is disposed inside the main frames 9.

The supercharging device 32 can increase the output of the motorcycle 1. The intake-air which has been compressed by the supercharging device 32 is sent to the air-intake chamber 33. The air-intake chamber 33 stores therein the intake-air having been compressed by the supercharging device 32 and then guides (leads) the intake-air to a combustion chamber of the engine E through the throttle device 16. The air-intake chamber 33 serves to suppress a change in a pressure in the air-intake passage. With an increase in the volume of the air-intake chamber 33, the output of the motorcycle 1 is increased. The air which has been consumed in the combustion of the engine E is discharged through an exhaust pipe 37.

The supercharging device 32 used in the present embodiment is a supercharging device of a supercharger type, which obtains a driving force for driving the supercharging device 32, from the output shaft of the engine E. Therefore, the supercharging device 32 has a characteristic in which a supercharging pressure increases in proportion to an engine speed. In addition, the supercharging device 32 has a characteristic in which the supercharging pressure tends to be high even in a state in which the engine speed is relatively low, compared to a supercharging device of a turbocharger type which utilizes an exhaust gas.

The throttle device 16 includes a throttle valve 21 disposed at an intermediate portion of the air-intake passage 20. The throttle valve 21 is connected to the throttle grip 7 via a throttle link 23. The throttle valve 21 is configured to be opened or closed in response to the rider's operation of the throttle grip 7. The throttle link 23 may be a throttle wire which mechanically connects the throttle grip 7 to the throttle valve 21, or an electric wire through which an electric signal formed by converting the operation amount of the throttle grip 7, is transmitted to the throttle valve 21. In other words, the present configuration is applicable to the throttle device 16 which is mechanically driven and the throttle device 16 which is electronically controlled. The throttle device 16 is provided with a fuel injection device (not shown) which injects fuel into the air-intake passage 20. The transmission 14 changes the driving power of the engine E and transmits the driving power to the rear wheel 3. The transmission 14 is provided with a clutch (not shown) operated to transmit or cut off the driving power.

As shown in FIG. 2, an engine ECU 17 performs calculation relating to an engine control based on signals received from sensors and switches, by electric power supplied from a battery (not shown), and provides control commands to electric devices, respectively. The sensors and the switches are, for example, a throttle position sensor, a clutch switch, a gear position sensor, an engine speed sensor, etc. The electric devices are ignition system devices such as an igniter, air-intake system devices such as a fuel injection device and an electric throttle valve, cooling system devices such as a cooling fan, sensors used for the driving control of the engine, the engine ECU 17, lamp units, audio units, etc.

A pressure rising suppressing mechanism 40 for suppressing an increase in the pressure in the air-intake chamber 33 is mounted to the air-intake chamber 33. The pressure rising suppressing mechanism 40 includes a pressure rising suppressing valve 41 which is actuated by a pressure (pressure actuated pressure rising suppressing valve 41), and a control valve 42 which is electrically actuated (electrically actuated control valve 42).

The pressure rising suppressing valve 41 is connected to the air-intake chamber 33 and is configured to open an inner space 33a of the air-intake chamber 33 to a relief passage 44 when a difference between a preset pressure in a pilot space 43 and the pressure in the air-intake chamber 33 reaches a predetermined value or more. The relief passage 44 is connected to the air-intake duct 34 located upstream of the supercharging device 32. When the inner space 33a of the air-intake chamber 33 is opened to the relief passage 44, the intake-air is circulated in a region upstream of the throttle device 16. This makes it possible to suppress an increase in the pressure in the air-intake chamber 33. The control valve 42 is configured to be capable of switching a space to be in communication with the pilot space 43, between a high-pressure space 45 having a specified pressure and a low-pressure space 46 having a pressure lower than that of the inner space 33a of the air-intake chamber 33. The engine ECU 17 functions as a valve controller 61 which provides to the control valve 42 an operation command for controlling the control valve 42. Specifically, the control valve 42 switches the space to be in communication with the pilot space 43 in response to the operation command provided by the valve controller 61. For example, the control valve 42 can be realized by an electromagnetic valve having a general configuration, which performs a switching operation by changing a voltage to be applied.

Specifically, the control valve 42 includes a valve element 42a which switches the space to be in communication with the pilot space 43, between the high-pressure space 45 and the low-pressure space 46, and an actuator 42b which actuates the valve element 42a in response to the operation command received from the engine ECU 17 which functions as the valve controller 61. The control valve 42 moves the valve element 42a to a closed position (indicated by a solid line of FIG. 2) at which the pilot space 43 and the low-pressure space 46 are in communication with each other when the signal voltage which is the operation command from the valve controller 61 has a signal voltage L, or to an open position (indicated by a dotted line of FIG. 2) at which the pilot space 43 and the high-pressure space 45 are in communication with each other when the signal voltage has a second signal voltage H higher than the first signal voltage L. According to the switching operation of the control valve 42, the opening/closing operation of the pressure rising suppressing valve 41 is performed.

Hereinafter, the configuration of the pressure rising suppressing mechanism 40 of the present embodiment will be described more specifically with reference to FIG. 2. The pressure rising suppressing valve 41 is realized as a pressure actuated valve having a general configuration, in which the valve element is opened or closed according to the difference between the pressure in the pilot space 43 and the pressure in the air-intake chamber 33. For example, the pressure rising suppressing valve 41 includes a valve seat 71 mounted to the air-intake chamber 33, and a valve casing 72 provided on the valve seat 71. The valve casing 72 accommodates therein a valve element 47 disposed between the inner space 33a of the air-intake chamber 33 and the relief passage 44, and performs switching between a state in which the inner space 33a of the air-intake chamber 33 and the inner space of the relief passage 44 are in communication with each other, and a state in which these spaces are disconnected from each other, a biasing mechanism 48 which biases the valve element 47 in a direction A in which these spaces are disconnected from each other (direction in which the valve element 47 is closed), and a diaphragm 49 which partitions the inner space of the valve casing 72 into a first space 41a and a second space 41b. The first space 41a is connected to the pilot space 43, while the second space 41b is connected to the inner space 33a of the air-intake chamber 33. The valve element 47 is movable in a direction in which the valve element 47 is opened or closed, according to the movement of the diaphragm 49. The diaphragm 49 is deformable in such a manner that the valve element 47 is movable in the direction in which the valve element 47 is opened or closed according to a pressure difference between the first space 41a and the second space 41b. The basing mechanism 48 is constituted by an elastic member such as a spring. The pressure rising suppressing valve 41 is connected to the air-intake chamber 33 via a connection pipe (not shown) connected to the opening of the air-intake chamber 33.

When the diaphragm 49 is deformed in the direction A in which the volume of the first space 41a is increased due to the pressure in the pilot space 43 and the biasing force applied by the basing mechanism 48, the valve element 47 is brought into contact with the valve seat 71, so that the inner space 33a of the air-intake chamber 33 and the inner space of the relief passage 44 are disconnected from each other (indicated by a solid line of FIG. 2). On the other hand, when the diaphragm 49 is deformed in a direction B in which the volume of the second space 41b is increased due to the pressure in the inner space 33a of the air-intake chamber 33, the valve element 47 moves away from the valve seat 71 against the biasing force applied by the basing mechanism 48, so that the inner space 33a of the air-intake chamber 33 and the inner space of the relief passage 44 are in communication with each other (indicated by a dotted line of FIG. 2).

To this end, the structure of the diaphragm 49 and the biasing force applied by the biasing mechanism 48 are set so that the valve element 47 is in contact with the valve seat 71 in a case where the pressure in the pilot space 43 is equal to an atmospheric pressure, and is away from the valve seat 71 in a case where the pressure in the pilot space 43 is equal to the pressure in the air-intake chamber 33. In a case where the pressure in the pilot space 43 is PP, the pressure in the air-intake chamber 33 is PA, the pressure-receiving area of the diaphragm 49 is A, and the biasing force applied by the biasing mechanism 48 is F, the inner space 33a of the air-intake chamber 33 and the inner space of the relief passage 44 are disconnected from each other, when A(PA−PP)<F is met, and are in communication with each other when A(PA−PP)>F is met. By increasing the pressure-receiving area of the diaphragm 49 and/or the pressure difference between the first space 41a and the second space 41b, a driving force applied to the valve element 47 can be easily increased. This makes it possible to easily increase the amount of the intake-air to be discharged from the inner space 33a of the air-intake chamber 33 to the relief passage 44, when the valve element 47 causes the inner space 33a of the air-intake chamber 33 and the inner space of the relief passage 44 to be in communication with each other.

As described above, the pressure rising suppressing valve 41 is configured in such a manner that the valve element 47 performs the opening/closing operation depending on whether or not pressure energy in the opening direction of the valve element 47 which is generated due to the pressure difference between the pilot space 43 and the inner space of the air-intake chamber 33 is greater than the biasing force applied by the biasing mechanism 48. Therefore, the valve element 47 can perform the opening/closing operation without a need to externally exert a particular driving force to the valve element 47.

In a case where a predetermined open condition is not met, the valve controller 61 moves the valve element 42a of the control valve 42 to the closed position. In this case, at the valve element 47 of the pressure rising suppressing valve 41, the difference between the pressure (the pressure in the direction A in which the valve element 47 is closed) applied from the pilot space 43 side and the pressure in the direction B in which the valve element 47 is opened, which is the pressure in the air-intake chamber 33, is small. In the present embodiment, this pressure difference is substantially zero. For this reason, the driving force is applied to the valve element 47 in the direction A in which the valve element 47 is closed, by the biasing force applied by the biasing mechanism 48. Therefore, the pressure rising suppressing valve 41 disconnects the air-intake chamber 33 and the relief passage 44 from each other, and thus a pressure increase in the inner space 33a of the air-intake chamber 33 is permitted.

In a case where the predetermined open condition is met, the valve controller 61 moves the valve element 42a of the control valve 42 to the open position. In this case, the pressure in the air-intake chamber 33 (the force applied in the direction B in which the valve element 47 is opened) is greater than the pressure applied from the pilot space 43 side and the biasing force applied by the biasing mechanism 48 (the force applied in the direction A in which the valve element 47 is closed). The driving force is applied to the valve element 47 of the pressure rising suppressing valve 41 in the direction B in which the valve element 47 is opened. Therefore, the pressure rising suppressing valve 41 is opened, and the air-intake chamber 33 and the relief passage 44 are in communication with each other. As a result, an increase in the pressure in the air-intake chamber 33 can be suppressed.

As described above, since the pressure rising suppressing valve 41 drives the valve element 47 by making use of the pressure energy, the size of the valve element 47 can be easily increased, and the flow rate of the intake-air (the amount of the intake-air discharged to atmospheric air) flowing from the air-intake chamber 33 to the relief passage 44 when the valve element 47 is opened can be increased. This makes it possible to suppress an increase in the supercharging pressure (the pressure in the air-intake chamber 33) as quickly as possible. In contrast, it is sufficient that the control valve 42 is electrically driven to move the valve element to an extent that the pressure is led to the pilot space 43. For this reason, the operation amount of the valve element of the control valve 42 is smaller than that of the pressure rising suppressing valve 41. Therefore, the size and weight of the control valve 42 can be reduced, compared to the pressure rising suppressing valve 41.

At the pressure rising suppressing valve 41, since the intake-air is circulated while the inner space of the air-intake chamber 33 is opened to the relief passage 44, the large amount of the intake-air in a high-temperature state flows from the interior of the air-intake chamber 33 through the valve element 47. For this reason, the pressure rising suppressing valve 41 is required to have a high heat resistance. In contrast, even in a state in which the pilot space 43 is in communication with the high-pressure space 45, the valve element 42a closes the passage (high-pressure space 45) on the air-intake chamber 33 side. Therefore, the amount of the intake-air which flows from the interior of the air-intake chamber 33 through the valve element 47 is less. For this reason, the control valve 42 may have a heat resistance lower than that of the pressure rising suppressing valve 41. Therefore, the electrically actuated valve may be used as the control valve 42. Preferably, the control valve 42 is located to be distant from the air-intake chamber 33. This makes it possible to prevent heat from being transferred from the air-intake chamber 33 to the control valve 42, and thereby suppress a temperature increase of the control valve 42. Since the length of the high-pressure space 45 is increased due to a configuration in which the control valve 42 is located to be distant from the air-intake chamber 33, the temperature of the intake-air flowing through the control valve 42 can be lowered. For example, the control valve 42 is disposed upstream (namely, forward) of the air-intake chamber 33 in a traveling direction of the motorcycle 1. In this layout, the temperature increase of the control valve 42 can be suppressed more effectively by the air flowing from forward.

In accordance with the above-described configuration, the pressure actuated pressure rising suppressing valve 41 having a heat resistance higher than that of the electrically actuated valve is used. For this reason, even in a case where the temperature of the interior of the air-intake chamber 33 is high, the pressure rising suppressing valve 41 can be properly operated. The electrically actuated control valve 42 which is actuated in response to the operation command provided by the valve controller 61 causes the pressure rising suppressing valve 41 to perform the opening/closing operation. Since the operation command is provided to the control valve 42, the pressure rising suppressing valve 41 can be opened or closed at a desired timing. Therefore, it becomes possible to properly set the timing when the inner space of the air-intake chamber 33 is opened to the relief passage 44.

If a supercharging condition is met even in a case where the pressure in the air-intake chamber 33 is higher than a predetermined pressure, a control which permits the increase in the pressure in the air-intake chamber 33 may be performed. For example, in a case where a throttle valve is closed slowly, and the pressure in the air-intake chamber 33 is not rapidly increased, the pressure rising suppressing valve 41 may remain closed. Or, for example, in a case where it is necessary to suppress the engine output, the pressure rising suppressing valve 41 can be actuated irrespective of the pressure in the air-intake chamber 33.

Further, in the motorcycle 1 of the present embodiment, in which the supercharging device 32 is driven by the rotation of the crankshaft of the engine E, the supercharging device 32 continues to be driven so long as the output shaft of the engine E rotates, even in a state in which the pressure in the air-intake chamber 33 is high. For this reason, the pressure in the air-intake chamber 33 tends to become high. Even in the motorcycle 1 including the supercharging device 32 having such a characteristic, by controlling the opening/closing operation of the pressure actuated pressure rising suppressing valve 41 by use of the electrically actuated control valve 42, the timing at which the inner space of the air-intake chamber 33 is opened to the relief passage 44 can be properly set without additionally providing a structure which can cut off the driving power generated in the engine E and the driving force applied to the supercharging device 32.

In the present embodiment, the high-pressure space 45 is in communication with the inner space of the air-intake chamber 33. In this configuration, in a case where the control valve 42 causes the high-pressure space 45 and the pilot space 43 to be in communication with each other, a pressure difference between the pilot space 43 and the interior of the air-intake chamber 33 is eliminated. This makes it possible to prevent a situation in which the pressure rising suppressing valve 41 is opened by mistake. Also, the low-pressure space 46 is an atmospheric pressure space. In this configuration, if the pressure in the air-intake chamber 33 is high in a case where the control valve 42 causes the low-pressure space 46 and the pilot space 43 to be in communication with each other, a pressure difference can be generated between the pilot space 43 and the interior of the air-intake chamber 33. Therefore, at a time point when the pressure difference reaches a predetermined value or more, the pressure rising suppressing valve 41 can be properly opened. Further, even when the throttle valve 21 has a failure, the relief passage 44 can be easily opened.

Now, the open condition (condition in which the air-intake chamber 33 is opened to the relief passage 44) used to move the valve element of the control valve 42 to the open position at which the pilot space 43 is in communication with the low-pressure space 46 will be exemplarily described. FIG. 3 is a graph showing a relation between the intake-air flow rate and the pressure (internal pressure) in the air-intake chamber. FIG. 3 shows the relation between the intake-air flow rate and the pressure in the air-intake chamber 33, at a plurality of engine speeds N₁ to N₅ (N₁<N₂<N₃<N₄<N₅). If the intake-air flow rate becomes lower under an equal engine speed, a surging tends to occur. FIG. 3 shows a surging area. In the motorcycle 1 including the supercharging device 32, if the supercharging pressure from the supercharging device 32 increases in a case where the throttle valve 21 is closed (off throttle), or a case where the throttle valve 21 is partially opened (partial throttle), a resistance is generated in the air-intake passage. This may result in a situation in which the air pressurized by the supercharging device 32 is stagnant in the air-intake chamber 33. In this situation, the air having been pressurized by the supercharging device 32 does not flow through the throttle valve 21 and flows back toward the supercharging device 32. This air is transmitted as a resistance to the rotating blade of the supercharging device 32. This phenomenon is called the surging. In the occurrence of the surging, the rotating blade of the supercharging device 32 vibrates, and may be damaged. In addition, if the pressure in the air-intake chamber 33 becomes equal to or higher than a predetermined limit pressure, irrespective of the intake-air flow rate, the air-intake chamber 33, the air-intake passage or the like may be destructed. FIG. 3 shows a destruction area. If the intake-air flow rate approaches a maximum value under the equal engine speed, the pressure in the air-intake chamber 33 tends to be reduced.

With an increase in the engine speed, the pressure in the air-intake chamber 33 tends to increase, and the maximum value of the intake-air flow rate tends to increase. The example of FIG. 3 shows a trend in which the pressure in the air-intake chamber 33 in the area (surging area) in which the surging tends to occur is higher and the maximum value of the intake-air flow rate is higher, as the engine speed is higher. However, depending on the characteristic(s) of the engine E and/or the supercharging device 32, a different trend is sometimes shown (e.g., the value of the pressure in the air-intake chamber 33 at which the surging occurs, in a state in which the engine speed is N₄, is smaller than that in a state in which the engine speed is N₃).

In a first control method of the present embodiment, the valve controller 61 controls the control valve 42 based on a value corresponding to the intake-air amount of the supercharging device 32 and the pressure in the air-intake chamber 33. In the present embodiment, the engine speed is used as the value corresponding to the intake-air amount of the supercharging device 32. In the present embodiment, the supercharging device 32 is driven by the driving power of the engine E (rotation of the crankshaft). Therefore, there is a correspondence between the engine speed and the intake-air amount of the supercharging device 32. Alternatively, the intake-air amount in the air-intake passage of the air-intake device 36 may be measured, and this measurement value may be used as the value corresponding to the intake-air amount of the supercharging device 32.

In the present embodiment, the motorcycle 1 includes an engine speed sensor 51 which measures the engine speed of the engine E, and a pressure sensor 52 which measures the pressure in the air-intake chamber 33. The valve controller 61 determines whether or not the pressure in the air-intake chamber 33 which is measured by the pressure sensor 52 is higher than a predetermined pressure value (limit pressure which will be described below) decided based on the engine speed, based on the engine speed measured by the engine speed sensor 51.

Specifically, the valve controller 61 controls the control valve 42 so that the pilot space 43 and the high-pressure space 45 are in communication with each other in an area in which the pressure in the air-intake chamber 33 is lower than a threshold (the limit pressure) of the air-intake chamber 33 which is set based on the engine speed, and the pilot space 43 and the low-pressure space 46 are in communication with each other in an area in which the pressure in the air-intake chamber 33 is equal to or higher than the limit pressure.

Note that the limit pressure set for each of the engine speeds may be constant irrespective of the engine speed. In other words, the set limit pressure may be set based on the destruction area of FIG. 3. However, this is exemplary, and the limit pressure may be set for each of the engine speeds. For example, the limit pressure may be set for each of the engine speeds, based on a boundary pressure with the surging area of FIG. 3. In the example of FIG. 3, the boundary pressure with the surging area is higher as the engine speed is higher.

In a second control method of the present embodiment, the valve controller 61 controls the control valve 42 based on the value (engine speed) corresponding to the intake-air amount of the supercharging device 32, and the throttle valve opening degree or the throttle operation amount. In the present embodiment, both of the first control method and the second control method are used. Alternatively, either one of these control methods may be used.

In the present embodiment, the motorcycle 1 includes a throttle valve opening degree sensor 53 which measures the opening degree of the throttle valve 21, and a throttle operation amount sensor 54 which measures the operation amount of the throttle grip 7. The valve controller 61 determines whether or not the pressure in the air-intake chamber 33 is higher than a predetermined pressure value with reference to the relation between the engine speed and the throttle valve opening degree or the throttle operation amount.

Specifically, the valve controller 61 controls the control valve 42 so that the pilot space 43 is in communication with the high-pressure space 45 in an area in which the throttle valve opening degree is higher than a threshold which is set based on the engine speed (area in which the pressure in the air-intake chamber 33 is low), and the pilot space 43 is in communication with the low-pressure space 46 in an area in which the throttle valve opening degree is equal to or lower than the threshold (area in which the pressure in the air-intake chamber 33 is high). For example, the following setting may be used. The threshold of the throttle valve opening degree is set for each predetermined engine speed (e.g., for each 1000 rpm). The threshold in a range between adjacent engine speeds corresponding to two thresholds is set to a value obtained by interpolating the two thresholds. Alternatively, a predetermined function may be used, and the threshold may be successively set to correspond to the engine speed.

With reference to the example of FIG. 3, the threshold of the throttle valve opening degree which is set based on the engine speed increases with an increase in the engine speed. This is merely exemplary, and the threshold of the throttle valve opening degree may be set in various ways based on the output characteristic or the like of the engine E.

As described above, if the intake-air flow rate is lower under the equal engine speed, the surging tends to occur. As shown in FIG. 3, if the intake-air flow rate becomes lower under the equal engine speed, the pressure in the air-intake chamber 33 increases. The intake-air flow rate changes under the equal engine speed, because the throttle valve opening degree is sometimes different under the equal engine speed. In other words, the intake-air flow rate and the corresponding pressure in the air-intake chamber 33 can be found based on the engine speed and the throttle valve opening degree. Therefore, by setting the threshold of the throttle valve opening degree corresponding to the engine speed and controlling the control valve 42 based on the set threshold, the pressure rising suppressing valve 41 can be controlled based on whether or not the pressure in the air-intake chamber 33 has exceeded the boundary pressure with the surging area. The threshold of the throttle valve opening degree may be set as a value of the throttle valve opening degree, corresponding to a pressure (a pressure in an area Z of FIG. 3) which is lower by a predetermined value than the boundary pressure with the surging area. By setting the threshold of the throttle valve opening degree with an allowance in this way, a probability with which the surging actually occurs can be effectively reduced.

Further, in addition to or instead of the throttle valve opening degree, the throttle operation amount may be set based on the engine speed. Specifically, in addition to or instead of directly measuring the opening degree of the throttle valve 21, the operation amount of the throttle grip 7 which is an operation member of the throttle valve 21 may be measured to indirectly measure the opening degree of the throttle valve 21, and the control valve 42 may be controlled based on this measurement value. In a case where the control valve 42 is controlled based on both of the throttle valve opening degree and the throttle operation amount, it is desirable to preferentially perform the control for the control valve 42 based on the threshold of the throttle valve opening degree obtained by directly measuring the movement of the throttle valve 21.

In the present embodiment, the engine ECU 17 functions as a failure determination unit 62 which determines whether or not there is a failure in the pressure rising suppressing valve 41 and/or the control valve 42. The failure determination unit 55 determines whether or not there is a failure in the pressure rising suppressing valve 41 and/or the control valve 42, based on the pressure in the air-intake chamber 33 which is measured by the pressure sensor 52, the operating state of the control valve 42, or the like. The operating state of the control valve 42 can be found by detecting the signal voltage of the operation command provided to the control valve 42. Further, a valve opening degree sensor which measures the opening degree(s) of the valve element of the control valve 42 and/or the valve element 47 of the pressure rising suppressing valve 41 may be provided to directly measure the opening degree(s) of the valve(s) 41, 42.

The failure determination unit 62 determines that there is a failure in the pressure rising suppressing valve 41 and/or the control valve 42, when any one of conditions or the like is met, the conditions including, for example, a case where the control valve 42 causes the pilot space 43 to be in communication with the high-pressure space 45 all the time (condition 1), a case where the control valve 42 causes the pilot space 43 to be in communication with the low-pressure space 46, and the pressure in the air-intake chamber 33 continues to fall within the above-described destruction area (the pressure in the air-intake chamber 33 is equal to or higher than the limit pressure) for a predetermined time or longer (condition 2), and a case where the control valve 42 causes the pilot space 43 to be in communication with the high-pressure space 45, and a change amount of the pressure in the air-intake chamber 33 for a predetermined time period in a preset range of the engine speed is less than a predetermined range (condition 3). The failure determination unit 62 determines whether or not there is a failure at a desired timing or a predetermined timing (when the engine E starts, the control valve 42 is operating, etc.).

Further, the engine ECU 17 functions as an engine output controller 63 which controls the output of the engine E based on a result of the determination performed by the failure determination unit 62. The engine output controller 63 suppresses the output of the engine E so that the pressure increase of the air-intake chamber 33 is suppressed, in a case where the failure determination unit 62 determines that the control valve 42 cannot cause the pressure rising suppressing valve 41 to open the air-intake chamber 33 to the relief passage 44.

For example, in a case where the failure determination unit 62 determines that one of the above-described conditions 1 to 3 is met, the engine output controller 63 suppresses the output of the engine E. For example, the engine output controller 63 may suppress the output of the engine E in such a manner that the electronically controlled throttle device 16 moves the throttle valve 21 toward a closed position, ignition performed by an ignition plug or fuel feeding is ceased in a state in which the engine speed is equal to or higher than a predetermined engine speed, an ignition timing is retarded, or a fuel feeding amount is changed. Thus, for example, even in a case where the pressure rising suppressing valve 41 remains unmovable, and thereby cannot cause the inner space of the air-intake chamber 33 to be in communication with the inner space of the relief passage 44, the situation in which the pressure increase of the air-intake chamber 33 cannot be suppressed does not happen. Desirably, the engine output controller 63 controls the engine speed so that the engine speed does not reach a supercharging engine speed range in which the supercharging pressure applied by the supercharging device 32 is equal to or higher than a predetermined value.

On the other hand, the engine output controller 63 may not perform the control for suppressing the output of the engine E, even in a case where the failure determination unit 62 determines that the control valve 42 cannot cause the pressure rising suppressing valve 41 to disconnect the inner space of the air-intake chamber 33 from the inner space of the relief passage 44. For example, when it is detected that the valve element 47 of the pressure rising suppressing valve 41 is opened all the time irrespective of the operation command provided to the control valve 42, in a case where the valve opening degree of the valve element 47 of the pressure rising suppressing valve 41 is directly measured, the failure determination unit 62 determines that there is a failure in the pressure rising suppressing valve 41. However, in this case, the situation in which the pressure increase of the air-intake chamber 33 cannot be suppressed does not happen. Therefore, the engine output controller 63 may not perform the control for suppressing the output of the engine E.

Further, the failure determination unit 62 may determine that there is a failure, when a ground (earth) fault or a short circuit in a control circuit including the engine ECU 17 takes place, and the engine output controller 63 may perform the control for suppressing the output of the engine E, based on this determination of the failure.

### Embodiment 2

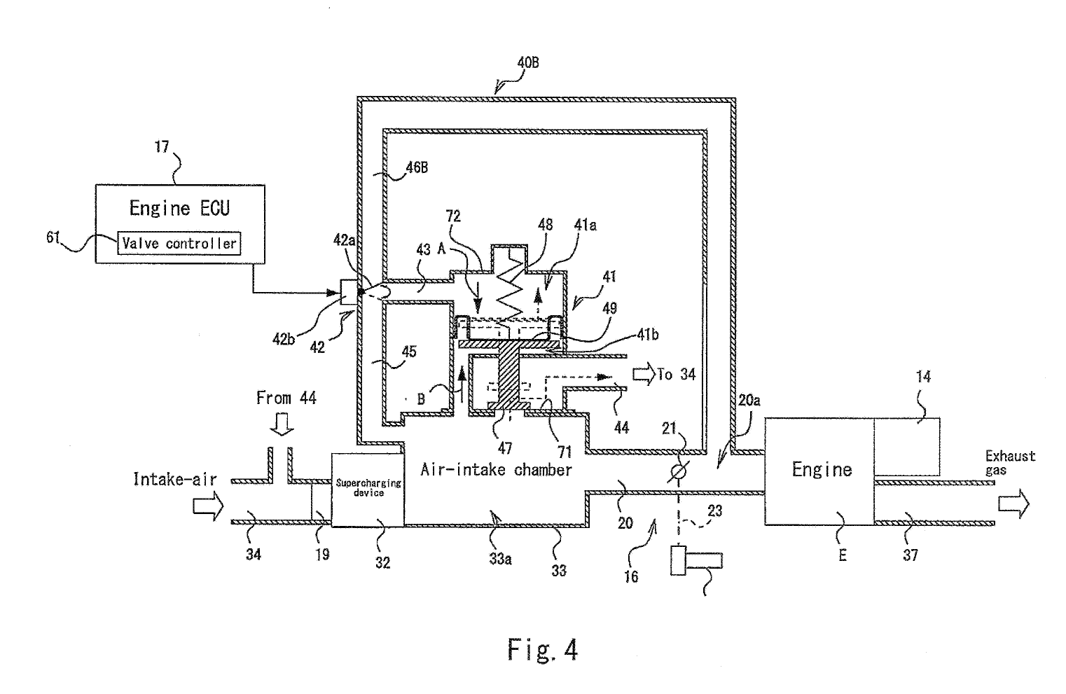

Next, Embodiment 2 will be described. FIG. 4 is a block diagram showing the schematic configuration of an air-intake passage of a motorcycle according to Embodiment 2 of the present invention. In the present embodiment, the same constituents as those of Embodiment 1 are designated by the same reference symbols and will not be described repeatedly. In the present embodiment, for example, the engine output can be controlled to be suppressed according to determination of a failure, as in Embodiment 1.

A pressure rising suppressing mechanism 40B of the motorcycle of the present embodiment is different from the pressure rising suppressing mechanism 40 of Embodiment 1 in that a low-pressure space 46B is an air-intake passage 20a located downstream of the throttle device 16. Specifically, when the control valve 42 causes the low-pressure space 46 and the pilot space 43 to be in communication with each other, the pilot space 43 is in communication with the air-intake passage 20a located downstream of the throttle valve 21 in the air-intake passage 20.

The air-intake passage 20a located downstream of the throttle device 16 tends to have a pressure (negative pressure) lower than an atmospheric pressure. In many cases, the pressure in the air-intake chamber 33 tends to be high in a state in which the throttle valve 21 is closed. In this state, a pressure in the air-intake passage 20a is particularly low. Therefore, by making use of the negative pressure as the pressure for opening the pressure rising suppressing valve 41, the responsivity of the pressure rising suppressing valve 41 can be improved. In a case where the pressure rising suppressing valve 41 is biased to be closed by the biasing mechanism 48, like the present embodiment, the pressure rising suppressing valve 41 is moved in a direction opposite to the basing direction (direction A of FIG. 7) of the biasing mechanism 48. Therefore, by making use of the negative pressure, a force against the biasing force applied by the biasing mechanism 48 can be easily obtained. Therefore, the biasing force applied by the biasing mechanism 48 can be increased. As a result, it becomes possible to prevent a situation in which the pressure rising suppressing valve 41 is undesirably opened.

Thus far, the embodiments of the present invention have been described. The present invention is not limited to the above-described embodiments. For example, although in the above-described embodiments, the motorcycle 1 includes one pressure actuated pressure rising suppressing valve 41, it may include a plurality of pressure actuated pressure rising suppressing valves 41. In this case, the electrically actuated control valve 42 may be common to the plurality of pressure actuated pressure rising suppressing valves 41. In other words, the plurality of pressure rising suppressing valves 41 may be controlled together by one control valve 42. In accordance with this configuration, by controlling one control valve 42, the plurality of pressure rising suppressing valves 41 can be driven. Therefore, the amount of the intake-air which can be discharged can be easily adjusted by changing the number of the pressure rising suppressing valves 41. Instead of this, a plurality of control valves 42 may be provided to correspond to a specified number of pressure rising suppressing valves 41, respectively, and the pressure rising suppressing valves 41 may be individually controlled.

Further, an electrically actuated pressure rising suppressing valve may be provided in the air-intake chamber 33 in addition to the pressure actuated pressure rising suppressing valve 41.

In the above-described embodiments, the pressure increase of the air-intake chamber 33 can be suppressed without providing an intercooler for cooling the air-intake chamber 33. Nonetheless, the present invention may be applied to a straddle-type vehicle including the intercooler.

The high-pressure space 45 may be an exhaust passage of the engine E. A pressure (exhaust gas pressure) in the exhaust passage of the engine E is a negative pressure. Therefore, as in Embodiment 2 which makes use of the negative pressure, the exhaust gas pressure can be utilized to open the pressure rising suppressing valve 41.

Instead of using the driving power of the engine E as the driving force for driving the supercharging device 32, a drive source such as a motor may be additionally provided to drive the supercharging device 32, or the driving force may be taken out of exhaust gas energy.

A condition different from the conditions exemplarily described in the above-described embodiments may be used as the open condition of the pressure rising suppressing valve 41. For example, the pressure rising suppressing valve 41 may be opened or closed only based on the pressure in the air-intake chamber 33. Since an electromagnetic valve which can be driven without depending on the pressure difference is used as the control valve 42, a condition different from the pressure in the air-intake chamber 33 may be set as the open condition of the pressure rising suppressing valve 41. For example, in a case where an exhaust gas temperature or a cooling water temperature has exceeded a predetermined value, the pressure rising suppressing valve 41 may be opened to suppress the increase in the supercharging pressure. Further, the pressure rising suppressing valve 41 may be controlled to be opened based on a condition in which suppressing the increase in the supercharging pressure is required.

Although in the above-described embodiments, the motorcycle has been exemplarily described as the straddle-type vehicle, the straddle-type vehicle is not limited to the motorcycle, and may be other kinds of straddle-type vehicles. For example, the straddle-type vehicle may be a four-wheeled vehicle having a residence space, such as a multi-purpose vehicle, or a vehicle such as a small ship.

Numerous improvements and alternative embodiment of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention. INDUS TRIAL APPLICABILITY

The straddle-type vehicle of the present invention is effectively used to properly set a timing at which the inner space of the air-intake chamber is opened.

### LIST OF REFERENCE CHARACTERS

1 motorcycle (straddle-type vehicle)
16 throttle device
20a air-intake passage located downstream of throttle device
32 supercharging device
33 air-intake chamber
41 pressure rising suppressing valve
42 control valve
43 pilot space
44 relief passage
45 high-pressure space
46 low-pressure space
61 valve controller
62 failure determination unit
63 engine output controller
E engine

1. A straddle-type vehicle comprising:
a supercharging device which compresses intake-air;
an air-intake chamber which is disposed downstream of the supercharging device, stores therein the intake-air having been compressed by the supercharging device, and guides the intake-air to a combustion chamber of an engine;
a pressure rising suppressing valve which is actuated by a pressure and connected to an inner space of the air-intake chamber, the pressure rising suppressing valve being configured to open the inner space of the air-intake chamber to a relief passage, in a case where a difference between a preset pressure in a pilot space and a pressure in the air-intake chamber reaches a predetermined value or more;
a control valve which is electrically actuated and is capable of performing switching of a space to be in communication with the pilot space, between a high-pressure space and a low-pressure space; and
a valve controller which provides to the control valve an operation command for controlling the control valve.

2. The straddle-type vehicle according to claim 1,
wherein the high-pressure space is the inner space of the air-intake chamber.

3. (canceled)

4. The straddle-type vehicle according to claim 1, comprising:
a throttle device disposed between the air-intake chamber and an intake port of the engine, to adjust a flow rate of the intake-air to be supplied to the engine,
wherein the low-pressure space is an air-intake passage located downstream of the throttle device.

5. The straddle-type vehicle according to claim 1,
wherein the valve controller controls the control valve based on a value corresponding to an air-intake amount of the supercharging device and the pressure in the air-intake chamber.

6. The straddle-type vehicle according to claim 1,
wherein the valve controller controls the control valve based on a value corresponding to an air-intake amount of the supercharging device and a throttle valve opening degree or a throttle operation amount.

7. The straddle-type vehicle according to claim 1, comprising:
a failure determination unit which determines whether or not there is a failure in the pressure rising suppressing valve; and
an engine output controller which suppresses an output of the engine to suppress a pressure increase of the air-intake chamber, in a case where the failure determination unit determines that the control valve cannot cause the pressure rising suppressing valve to open the inner space of the air-intake chamber to the relief passage.

8. The straddle-type vehicle according to claim 1,
wherein the control valve is disposed to be distant from the air-intake chamber, and located upstream of the air-intake chamber in a traveling direction of the straddle-type vehicle.

9. The straddle-type vehicle according to claim 8,
wherein the low-pressure space is an atmospheric pressure space.

10. The straddle-type vehicle according to claim 1,
wherein the valve controller obtains an engine speed and a throttle valve opening degree or a throttle operation amount corresponding to the engine speed,
controls the control valve so that the pilot space is in communication with the high-pressure space in an area in which the throttle valve opening degree or the throttle operation amount is higher than a threshold set based on the engine speed, and the pressure in the air-intake chamber is low, and
controls the control valve so that the pilot space is in communication with the low-pressure space in an area in which the throttle valve opening degree or the throttle operation amount is lower than the threshold, and the pressure in the air-intake chamber is high, and
wherein the threshold of the throttle valve opening degree or the throttle operation amount is set to be larger as the engine speed is higher.

11. The straddle-type vehicle according to claim 1,
wherein the air-intake chamber is configured to store therein the intake-air having been compressed by the supercharging device, to suppress a change in a pressure in an air-intake passage, and
wherein the pressure rising suppressing valve which is actuated by the pressure includes a plurality of pressure rising suppressing valves controlled to operate by the control valve which is electrically actuated and is a single control valve common to the plurality of pressure rising suppressing valves.

12. The straddle-type vehicle according to claim 1,
wherein the air-intake chamber has a volume larger than that of an air-intake passage which is other than the air-intake chamber, and
wherein the pressure rising suppressing valve is included in a pressure rising suppressing mechanism mounted to the air-intake chamber.

13. The straddle-type vehicle according to claim 1,
wherein the pressure rising suppressing valve includes a valve seat mounted to the air-intake chamber, and a valve casing provided on the valve seat.

14. The straddle-type vehicle according to claim 1,
wherein the supercharging device is driven by driving power generated by the engine.

15. The straddle-type vehicle according to claim 1,
wherein the straddle-type vehicle is a motorcycle.
